(19) United States
(12) Patent Application Publication
(10) Pub. No.: US 2026/0118511 A1
(43) Pub. Date: Apr. 30, 2026

(54) SYSTEM FOR IMAGING THE DISTANCE OF A SCENE

(71) Applicant: COMMISSARIAT A L'ENERGIE ATOMIQUE ET AUX ENERGIES ALTERNATIVES, Paris (FR)

(72) Inventors: Anis DAAMI, Grenoble Cedex 09 (FR); Florence RIGAL, Grenoble Cedex 09 (FR); Laurent FREY, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/366,663

(22) Filed: Oct. 23, 2025

(30) Foreign Application Priority Data
Oct. 28, 2024 (FR) FR2411760

(51) Int. Cl. G01S 17/34; G01S 7/481; G01S 7/4911; G01S 7/4912; G01S 7/4914; G01S 17/89

(52) U.S. Cl. CPC G01S 17/34; G01S 7/4814; G01S 7/4816; G01S 7/4911; G01S 7/4914; G01S 7/4917; G01S 17/89

(57) ABSTRACT

A system for imaging a scene, including an emitter configured to emit frequency-modulated continuous-wave laser radiation in a direction of propagation; an image sensor, including a set of photodetectors; an optical component, arranged to incorporate first and second splitting surfaces such that the first and second splitting surfaces intersect at right angles along a line of intersection perpendicular to the direction of propagation, and such that the first and second splitting surfaces are rotationally integral; a processor configured to process a heterodyne signal from each photodetector originating from a recombination of an object beam with a reference beam, so as to obtain a distance image of the scene.

### TECHNICAL FIELD

The invention relates to the technical field of systems for imaging the distance of a scene, more specifically a three-dimensional (3D) scene, based on the emission of coherent, frequency-modulated continuous waves (FMCW) with heterodyne detection.

The invention is notably applicable in facial recognition for mobile telephones, augmented reality, robotics, drones, logistics, industrial inspection, etc.

### PRIOR ART

A known prior art system for imaging the distance of a 3D scene uses light detection and ranging (LiDAR) technology with a frequency-modulated continuous wave (FMCW) laser source. This technology is generally referred to using the acronym LiDAR FMCW.

Conventionally, there are two types of interferometric setups for implementing this technology:
(i) a bistatic setup (for example, the Mach-Zehnder type) where the field of view (FOV) and the field of emission (FOE) are misaligned;
(ii) a monostatic setup (for example, the Michelson type) where the FOE and the FOV are aligned.

An example of a Mach-Zehnder type bistatic setup is illustrated in FIG. 1a. The system for imaging the distance of a scene 1 comprises:
emission means 2, configured to emit frequency-modulated continuous-wave laser radiation RL in a direction of propagation DP;
first and second optical splitter components C1, C2;
first and second detectors D1, D2.
   In case (i), the overlap between the FOE and the FOV is not total due to their misalignment, which varies as a function of the distance between the laser source 2 and the first detector D1. It should be noted that a bistatic setup allows a second detector D2 to be used with two channels to analyse the interference signal.

An example of a Michelson type monostatic setup is illustrated in FIG. 1b. The system for imaging the distance of a scene 1 comprises:
emission means 2, configured to emit frequency-modulated continuous-wave laser radiation RL in a direction of propagation DP;
first and second optical components C1, C2, with the first optical component C1 being a splitter component and the second optical component C2 being a mirror;
a detector D1.
   In case (ii), the overlap between the FOE and the FOV is total due to their alignment. However, a monostatic setup does not allow a second detector to be used. There is only one channel to analyse the interference signal.

Within the context of heterodyne detection, the alignment between the FOE and the FOV is a critical parameter for illuminating the entire scene viewed in the FOV and for precisely measuring the frequency of the beat signal of the oscillations produced by any interference.

Such interferometric setups of the prior art are not entirely satisfactory in so far as at least two optical components need to be adjusted in order to obtain and maintain precise alignment between the FOE and the FOV. In case (i), the two optical components can be two beam splitters or two beam splitter cubes. In case (ii), the two optical components can be a beam splitter (or a beam splitter cube) and the return mirror.

### DISCLOSURE OF THE INVENTION

The aim of the invention is to overcome all or some of the aforementioned disadvantages. To this end, the aim of the invention is a system for imaging the distance of a scene, comprising:
emission means, configured to emit frequency-modulated continuous-wave laser radiation in a direction of propagation;
an image sensor, comprising a set of photodetectors;
a first splitting surface, arranged to split the laser radiation into:
a first beam, called reference beam, reflected by the first splitting surface towards the image sensor, and into
a second beam, transmitted by the first splitting surface towards the scene;
   a second splitting surface, arranged to split the second beam reflected by the scene into:
a third beam, called object beam, reflected by the second splitting surface towards the image sensor, and into
a fourth beam, transmitted by the second splitting surface;
   an optical component, arranged to incorporate the first and second splitting surfaces such that the first and second splitting surfaces intersect at right angles along a line of intersection perpendicular to the direction of propagation, and such that the first and second splitting surfaces are rotationally integral;
   processing means, configured to process a heterodyne signal from each photodetector originating from a recombination of the object beam with the reference beam, so as to obtain a distance image of the scene.

Thus, such an imaging system according to the invention automatically guarantees (without adjusting optical components as in the prior art) alignment between the reference beam and the object beam (i.e., between the FOE and the FOV), by virtue of the optical component incorporating the first and second splitting surfaces such that the first and second splitting surfaces are rotationally integral. Such automatic alignment between the FOE and the FOV improves performance capabilities in terms of heterodyne efficiency and, thereby, the quality of the heterodyne signal of the distance (or depth) image.

Furthermore, such an imaging system according to the invention allows alignment of the FOE and the FOV on the same optical axis (unlike a Mach-Zehnder type setup) and the optional use of a second detector (unlike a Michelson type setup).

The imaging system according to the invention can comprise one or more of the following features.

According to one feature of the invention:
the laser radiation has a transverse extension with respect to the direction of propagation;
the optical component has a projection onto the transverse extension that fully covers the transverse extension.

Thus, one resulting advantage is to improve the performance capabilities of the system by avoiding parasitic diffraction phenomena at the edges of the optical component.

According to one feature of the invention, the imaging system comprises an optical isolator arranged to isolate the emission means from the fourth beam.

Thus, one resulting advantage is to improve the quality of the heterodyne signal.

According to one feature of the invention, the imaging system comprises a dioptric device, preferably a lens or an objective lens, arranged between the optical component and the scene so as to cause the second beam transmitted by the first splitting surface to diverge towards the scene, the dioptric device having an image focal plane in which the image sensor is arranged.

Thus, one advantage provided by the dioptric device is to diverge the second beam transmitted by the first splitting surface towards the scene in order to obtain a large FOE and to converge the image of the scene on the image sensor.

According to one feature of the invention, the imaging system comprises an additional image sensor comprising a set of additional photodetectors; with the second splitting surface being arranged to split the laser radiation into:
a fifth beam, called additional reference beam, reflected by the second splitting surface towards the additional image sensor, and into
a sixth beam, transmitted by the second splitting surface towards the scene;
   with the first splitting surface being arranged to split the sixth beam reflected by the scene into:
a seventh beam, called additional object beam, reflected by the first splitting surface towards the additional image sensor, and
an eighth beam, transmitted by the first splitting surface;
   with the processing means being configured to process a heterodyne signal from each additional photodetector originating from a recombination of the additional object beam with the additional reference beam, so as to obtain a distance image of the scene.

Thus, one resulting advantage is to provide a second channel for analysing the heterodyne signal.

According to one feature of the invention, the optical isolator is arranged to isolate the emission means from the eighth beam.

Thus, one resulting advantage is to improve the quality of the heterodyne signal received by each additional photodetector.

According to one feature of the invention, the dioptric device is arranged between the optical component and the scene so as to cause the sixth beam transmitted by the second splitting surface to diverge towards the scene, the additional image sensor being arranged in the image focal plane of the dioptric device.

Thus, one advantage provided by the dioptric device is to diverge the sixth beam transmitted by the second splitting surface towards the scene in order to obtain a large FOE and to converge the image of the scene on the additional image sensor.

According to one feature of the invention, the optical component comprises a set of optical prisms arranged such that their interfaces form the first and second splitting surfaces.

Thus, one advantage provided by the optical prisms is that they confer high stability to the system in order to obtain a quality heterodyne signal that can be easily used with an optimised beat signal. In particular, the optical prisms are not internally affected by mechanical vibrations that could alter the relative positioning of the first and second splitting surfaces.

According to one feature of the invention, the optical component is a cube comprising four triangular optical prisms arranged to form an “X”-shaped configuration.

Thus, one advantage provided by such a component is its ease of manufacture. It should be noted that the dichroic property of X-cubes (trade name) is not useful within the context of the invention. The four triangular optical prisms, which are arranged to obtain an “X”-shaped configuration, are advantageously devoid of dichroic coatings.

According to one feature of the invention, the first and second splitting surfaces each have a reflection coefficient of 50% and a transmission coefficient of 50%.

Thus, one resulting advantage is to maximise the intensity of the heterodyne signal.

### Definitions

“Scene” is understood to mean all objects, surfaces, textures, etc., arranged in a three-dimensional space, which are captured by the imaging system.

“Splitting surface” is understood to mean a surface designed to spatially split an incident beam into two distinct beams.

“Incorporate” is understood to mean that the first and second splitting surfaces are integrated inside the optical component in such a way as to achieve mechanical integrity, notably by rotation, between the optical component and the first and second splitting surfaces. In other words, the first and second splitting surfaces cannot be moved independently of the optical component.

“Intersect at right angles” is understood to mean that the planes defining the first and second splitting surfaces form a dihedral angle of 90°.

“Line of intersection” is understood to mean the line (more specifically, the line segment) shared by the two planes defining the first and second splitting surfaces. In other words, the “line of intersection” is the common edge along which the two planes defining the first and second splitting surfaces meet.

“Heterodyne signal” is understood to mean a signal originating from the superposition (interference) of two light waves with different frequencies, used to measure the frequency shifts between the reference beam and the object beam, and to deduce information concerning the distance and the speed of the scene therefrom. More specifically, the interference generates beats whose frequency corresponds to the difference between the frequencies of the two superimposed waves.

“Optical isolator” is understood to mean an optical component designed to allow light to propagate in a single specific direction, while blocking its return in the opposite direction.

“Dioptric device” is understood to mean a device comprising a set of dioptres for modifying the propagation of light by refraction.

“Reflection coefficient” is understood to mean an intensity reflection coefficient at the wavelength of the laser radiation.

“Transmission coefficient” is understood to mean an intensity transmission coefficient at the wavelength of the laser radiation.

### BRIEF DESCRIPTION OF THE DRAWINGS

Further features and advantages will become apparent from the detailed description of various embodiments of the invention, which description is accompanied by examples and references to the accompanying drawings.

FIG. 1a (already discussed) is a schematic diagram of an imaging system according to the prior art using a bistatic Mach-Zehnder type setup.

FIG. 1b (already discussed) is a schematic diagram of an imaging system according to the prior art using a Michelson-type monostatic setup.

FIG. 2 is a schematic diagram of an imaging system according to the invention, illustrating the outward path (i.e., upstream of the scene) of the laser radiation, according to an embodiment involving a single detector (one channel).

FIG. 3 is a schematic diagram of an imaging system according to the invention, illustrating the return path (i.e., downstream of the scene) of the laser radiation, according to an embodiment involving a single detector (one channel).

FIG. 4 is a schematic diagram of an imaging system according to the invention, illustrating the outward path (i.e., upstream of the scene) of the laser radiation, according to an embodiment involving two detectors (two channels).

FIG. 5 is a schematic diagram of an imaging system according to the invention, illustrating the return path (i.e., upstream of the scene) of the laser radiation, according to an embodiment involving two detectors (two channels).

FIG. 6 is a schematic view illustrating an optical component used in an imaging system according to the invention.

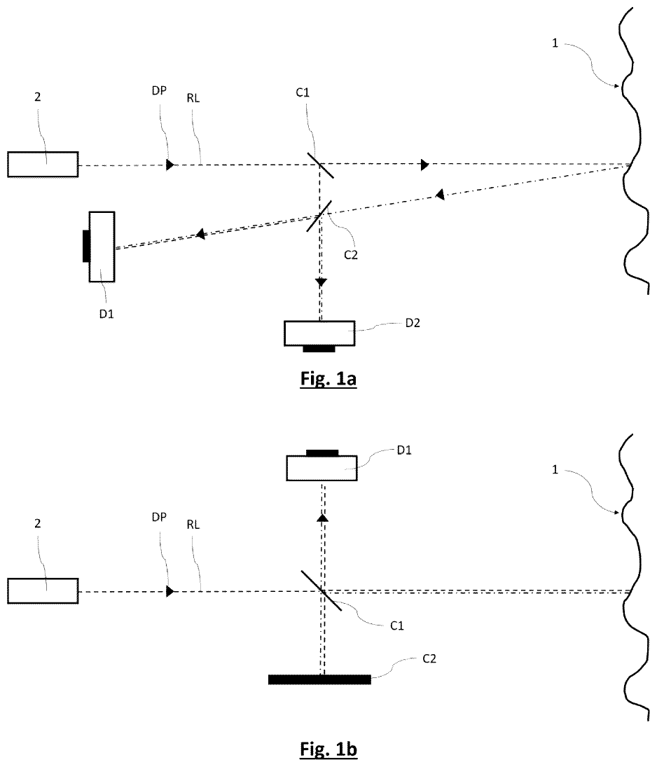

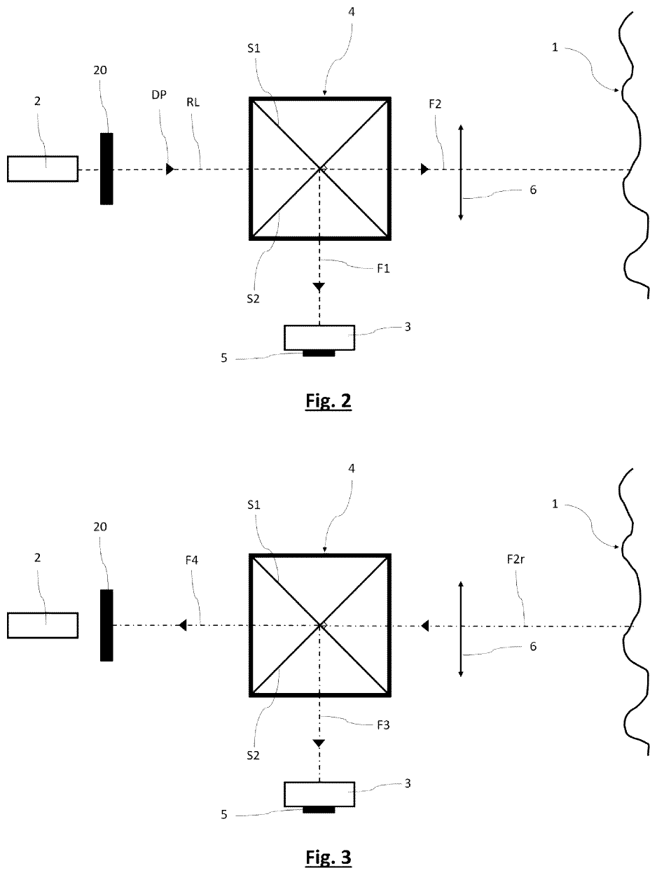

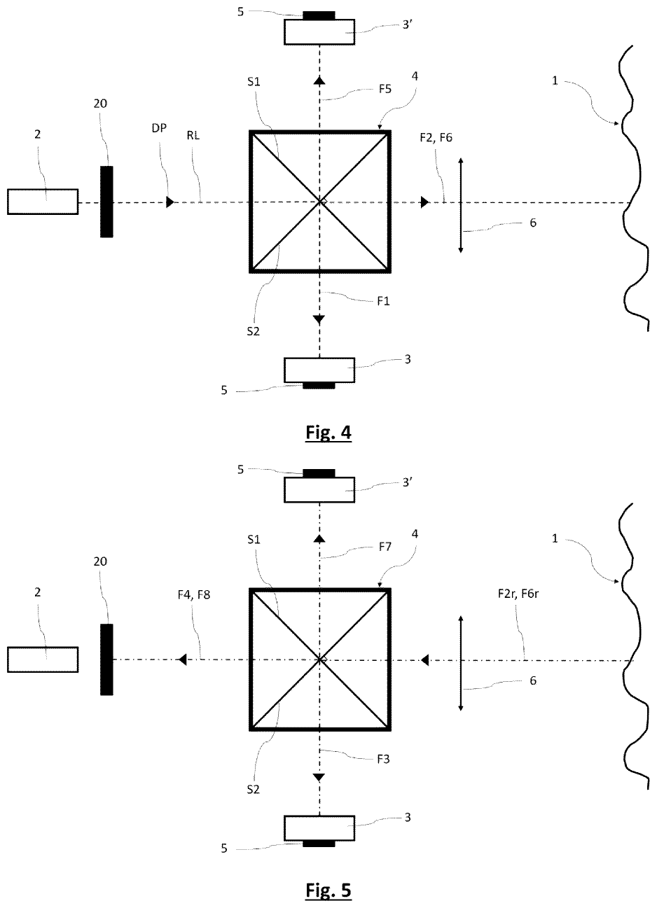

It should be noted that the drawings described above are schematic and are not necessarily to scale for the sake of readability and to simplify their understanding.

### DETAILED DISCLOSURE OF THE EMBODIMENTS

Identical elements or elements performing the same function will be given the same references for the various embodiments, for the sake of simplicity.

One aim of the invention is a system for imaging the distance of a scene 1, comprising:
emission means 2, configured to emit frequency-modulated continuous-wave laser radiation RL in a direction of propagation DP;
an image sensor 3, comprising a set of photodetectors;
a first splitting surface S1, arranged to split the laser radiation RL into:
a first beam F1, called reference beam, reflected by the first splitting surface S1 towards the image sensor 3, and into
a second beam F2, transmitted by the first splitting surface S1 towards the scene 1;
   a second splitting surface S2, arranged to split the second beam F2r reflected by the scene 1 into:
a third beam F3, called object beam, reflected by the second splitting surface S2 towards the image sensor 3, and into
a fourth beam F4, transmitted by the second splitting surface S2;
   an optical component 4, arranged to incorporate the first and second splitting surfaces S1, S2 such that the first and second splitting surfaces S1, S2 intersect at right angles along a line of intersection perpendicular to the direction of propagation DP, and such that the first and second splitting surfaces S1, S2 are rotationally integral;
   processing means 5, configured to process a heterodyne signal from each photodetector originating from a recombination of the object beam F3 with the reference beam F1, so as to obtain a distance image of the scene 1.

### Emission Means

The emission means 2 are configured to emit frequency-modulated continuous-wave laser radiation RL in a direction of propagation DP. The optical frequency of the laser radiation RL is preferably modulated with a periodic linear ramp.

The laser radiation RL has a transverse extension with respect to the direction of propagation DP.

By way of non-limiting examples, the emission means 2 comprise a laser source selected from an edge-emitting laser, a vertical-cavity surface-emitting laser diode, and a quantum-cascade laser.

By way of non-limiting examples, the wavelength of the laser radiation RL can be 850 nm (GaAs), 940 nm (InP), ranging in the 1.3 μm-1.55 μm range, ranging in the 3 μm-5 μm range, or ranging in the 8 μm-14 μm range.

### Image Sensor(s)

The image sensor 3 comprises a set of photodetectors.

The imaging system can comprise an additional image sensor 3′ comprising a set of additional photodetectors.

By way of non-limiting examples, the photodetectors can be selected from photodiodes (optionally avalanche photodiodes) and microbolometers (for infrared).

### Optical Component

The optical component 4 incorporates the first and second splitting surfaces S1, S2. In other words, the first and second splitting surfaces S1, S2 are integrated within the optical component 4 so as to obtain mechanical integrity, in particular rotational integrity.

The first and second splitting surfaces S1, S2 are incorporated into the optical component 4 so as to intersect at right angles along a line of intersection perpendicular to the direction of propagation DP of the laser radiation RL. The optical component 4 is advantageously arranged so as to project over the transverse extension of the laser radiation RL fully covering said transverse extension. By way of a non-limiting example, the projection of the optical component 4 over the transverse extension of the laser radiation RL can range between 3 mm and 1 cm.

The first splitting surface S1 is arranged to split the laser radiation RL into:
a first beam F1, called reference beam, reflected by the first splitting surface S1 towards the image sensor 3, and into
a second beam F2, transmitted by the first splitting surface S1 towards the scene 1.

The second splitting surface S2 is arranged to split the second beam F2r reflected by the scene 1 into:
a third beam F3, called object beam, reflected by the second splitting surface S2 towards the image sensor 3, and into
a fourth beam F4, transmitted by the second splitting surface S2.
   If an additional image sensor 3′ is present, the second splitting surface S2 is arranged to split the laser radiation RL into:
a fifth beam F5, called additional reference beam, reflected by the second splitting surface S2 towards the additional image sensor 3′, and into
a sixth beam F6, transmitted by the second splitting surface S2 towards the scene 1.
   If applicable, the first splitting surface S1 is arranged to split the sixth beam F6r reflected by the scene 1 into:
a seventh beam F7, called additional object beam, reflected by the first splitting surface S1 towards the additional image sensor 3′, and
an eighth beam F8, transmitted by the first splitting surface S1.

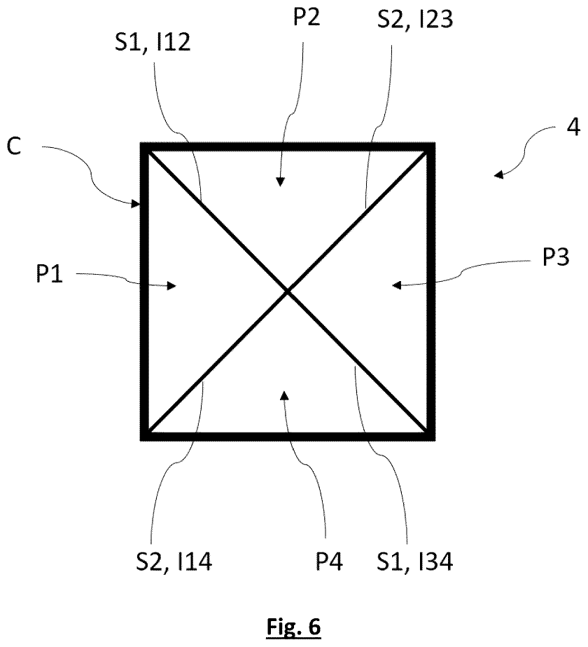

The optical component 4 advantageously comprises a set of optical prisms P1, P2, P3, P4 arranged so that their interfaces 112, 123, 134, 114 form the first and second splitting surfaces S1, S2. As illustrated in FIG. 6, the optical component 4 can comprise four optical prisms, denoted P1, P2, P3, P4 in clockwise order. The first splitting surface S1 is formed by the interface 112 between the first optical prism P1 and the second optical prism P2 and by the interface 134 between the third optical prism P3 and the fourth optical prism P4. The second splitting surface S2 is formed by the interface 123 between the second optical prism P2 and the third optical prism P3 and by the interface 114 between the first optical prism P1 and the fourth optical prism P4.

The optical component 4 advantageously is a cube C comprising four triangular optical prisms P1, P2, P3, P4 arranged to obtain an “X”-shaped configuration. The first and second splitting surfaces S1, S2 each advantageously have a reflection coefficient of 50% and a transmission coefficient of 50%.

### Processing Means

The processing means 5 are configured to process a heterodyne signal from each photodetector originating from a recombination of the object beam F3 with the reference beam F1, so as to obtain a distance image of the scene 1. The processing means 5 are electrically connected to the image sensors 3, 3′. The processing means 5 can be electrically connected to the emission means 2. However, ramps can be detected without necessarily electrically connecting the processing means 5 to the emission means 2.

Any interference between the object beam F3 and the reference beam F1 produces beats whose frequency corresponds to the difference between the frequencies of the object beam F3 and the reference beam F1. More specifically, when the optical frequency of the laser radiation RL is modulated with a periodic linear ramp, the beat frequency of the oscillations, denoted fr, complies with the following relationship:

$${f}_{R} = \frac{2 Bz}{cT}$$

where:
“T” is the duration of the ramp;
“c” is the speed of light in a vacuum;
“B” is the optical frequency excursion (“chirp”) of the laser radiation RL throughout the duration “T” of the ramp;
“z” is distance (depth) information on the scene 1.

An approximation of “z” can be deduced from the number of periods, denoted “N”, measured throughout the duration “T” of the ramp using the following formula (denoted Frm 1):

$$z \approx \frac{Nc}{2 B}$$

The distance resolution, denoted oz, can be approximated using the following formula:

$$δ z \approx \frac{c}{2 B}$$

It is therefore possible to obtain a distance map z=f(x, y), where “x” and “y” denote the coordinates of the scene 1 and “f” denotes a mathematical function.

If an additional image sensor 3′ is present, the processing means 5 are advantageously configured to process a heterodyne signal from each additional photodetector originating from a recombination of the additional object beam F7 with the additional reference beam F5, in order to obtain a distance image of the scene 1.

By way of a non-limiting example, the processing means comprise a processor configured to compute “z” from the formula “Frm 1” described above.

Such processing means 5 are known to a person skilled in the art.

### Dioptric Device

The imaging system advantageously comprises a dioptric device 6 arranged between the optical component 4 and the scene 1 so as to cause the second beam F2 transmitted by the first splitting surface S1 to diverge towards the scene 1.

The dioptric device 6 has an image focal plane in which the image sensor 3 is arranged. The focal length is selected so as to be less than the distance between the optical centre of the dioptric device 6 and the scene 1.

The dioptric device 6 is preferably a lens or an objective lens.

If an additional image sensor 3′ is present, the dioptric device 6 is advantageously arranged between the optical component 4 and the scene 1 so as to cause the sixth beam F6 transmitted by the second splitting surface S2 to diverge towards the scene 1. The additional image sensor 3′ is then advantageously arranged in the image focal plane of the dioptric device 6.

### Optical Isolator

The imaging system advantageously comprises an optical isolator 20 arranged to isolate the emission means 2 from the fourth beam F4. In other words, the fourth beam F4, transmitted by the second splitting surface S2, is isolated from the laser radiation RL by the optical isolator 20.

If an additional image sensor 3′ is present, the optical isolator 20 is advantageously arranged to isolate the emission means 2 from the eighth beam F8. In other words, the eighth beam F8, transmitted by the first splitting surface S1, is isolated from the laser radiation RL by the optical isolator 20.

By way of a non-limiting example, the optical isolator 20 can be a Faraday-type isolator.

The invention is not limited to the disclosed embodiments. A person skilled in the art will be able to consider technically effective combinations thereof and replace them with equivalents.

1. A system for imaging the distance of a scene, comprising:
emission means, configured to emit frequency-modulated continuous-wave laser radiation in a direction of propagation;
an image sensor, comprising a set of photodetectors;
a first splitting surface, arranged to split the laser radiation into:
a first beam, called reference beam, reflected by the first splitting surface towards the image sensor, and into
a second beam, transmitted by the first splitting surface towards the scene;
a second splitting surface, arranged to split the second beam reflected by the scene into:
a third beam, called object beam, reflected by the second splitting surface towards the image sensor, and into
a fourth beam, transmitted by the second splitting surface;
an optical component, arranged to incorporate the first and second splitting surfaces such that the first and second splitting surfaces intersect at right angles along a line of intersection perpendicular to the direction of propagation, and such that the first and second splitting surfaces are rotationally integral;
processing means, configured to process a heterodyne signal from each photodetector originating from a recombination of the object beam with the reference beam, so as to obtain a distance image of the scene.

2. The system according to claim 1, wherein:
the laser radiation has a transverse extension with respect to the direction of propagation;
the optical component has a projection onto the transverse extension that fully covers the transverse extension.

3. The system according to claim 1, comprising an optical isolator arranged to isolate the emission means from the fourth beam.

4. The system according to claim 1, comprising a dioptric device, arranged between the optical component and the scene so as to cause the second beam transmitted by the first splitting surface to diverge towards the scene, the dioptric device having an image focal plane wherein the image sensor is arranged.

5. The system according to claim 1, comprising an additional image sensor comprising a set of additional photodetectors;
with the second splitting surface being arranged to split the laser radiation into:
a fifth beam, called additional reference beam, reflected by the second splitting surface towards the additional image sensor, and into
a sixth beam, transmitted by the second splitting surface towards the scene;
with the first splitting surface being arranged to split the sixth beam reflected by the scene into:
a seventh beam, called additional object beam, reflected by the first splitting surface towards the additional image sensor, and into
an eighth beam, transmitted by the first splitting surface;
with the processing means being configured to process a heterodyne signal from each additional photodetector originating from a recombination of the additional object beam with the additional reference beam, so as to obtain a distance image of the scene.

6. The system according to claim 5, wherein the optical isolator is arranged to isolate the emission means from the eighth beam.

7. The system according to claim 5, wherein the dioptric device is arranged between the optical component and the scene so as to cause the sixth beam transmitted by the second splitting surface to diverge towards the scene, the additional image sensor being arranged in the image focal plane of the dioptric device.

8. The system according to claim 1, wherein the optical component comprises a set of optical prisms arranged such that their interfaces form the first and second splitting surfaces.

9. The system according to claim 8, wherein the optical component is a cube comprising four triangular optical prisms arranged to obtain an “X”-shaped configuration.

10. The system according to claim 1, wherein the first and second splitting surfaces each have a reflection coefficient of 50% and a transmission coefficient of 50%.
